(19) United States
(12) Patent Application Publication
(10) Pub. No.: US 2016/0258214 A1
(43) Pub. Date: Sep. 8, 2016

(54) Curved Ladder for Tank Access

(71) Applicant: Steven Richard Ambriz, Missouri City, TX (US)

(72) Inventor: Steven Richard Ambriz, Missouri City, TX (US)

(21) Appl. No.: 14/322,896

(22) Filed: Jul. 2, 2014

(51) Int. Cl. E06C 1/34; E06C 7/18; E06C 1/38

(52) U.S. Cl. CPC E06C 1/34; E06C 1/38; E06C 7/181

(57) ABSTRACT

A ladder assembly defines a work station for a tank having a vertically extending side wall and a top of a convex curved profile, with an access point near the top center of the convex curved top, the ladder having a pair of parallel side rails, each side rail having a straight section at one end and a curved section at the other end, the curved section extending over the top of the tank and toward the access point, with plurality of rungs extending between and secured to the side rails, with at least one rung positioned in the straight section of the side rails and at least one rung positioned in the curved section of the side rails. A separate hand grip is provided and may be mounted on the tank between the ladder and the access point of the tank.

### CROSS REFERENCE TO RELATED APPLICATION AND PATENTS

This application is a continuation-in-part of U.S. patent application Ser. No. 14/044,159, filed on Oct. 2, 2013, pending, which in turn is a continuation of U.S. patent application Ser. No. 13/490,159, filed on Jun. 7, 2014 and now abandoned, which in turn is a continuation of U.S. patent application Ser. No. 12/699,667, filed on Feb. 3, 2010 and now abandoned, all entitled: “Curved Ladder for Tank Access”, and claims priority to Feb. 3, 2010 based thereon. These applications are incorporated by reference herein.

### BACKGROUND OF THE INVENTION

1. Field of the Invention

The subject invention is generally directed to a mounted ladder assembly for installation on a tank or the like to provide a work station for permitting access to a portion of the tank not otherwise accessible and is specifically directed to a tank having curved outer walls and a curved ladder for such a tank. In one aspect of the invention, the work station provides access to a safety interlock closure system for a top access port. The safety interlock closure system is disclosed in the aforementioned U.S. Pat. No. 7,850,214. Elongated handles may be provided on the interlock system to further enhance the accessibility of the safety interlock closure system from the access ladder system. This also allows the operator to install lifting chains or harnesses.

2. Discussion of the Prior Art

Tanks for storing materials are well known. Such tanks generally have a port or access point at the top for filling, maintenance or other operations. The top opening or port permits access to the tank and its contents without releasing any of the materials stored therein, when the tank is properly pressurized or depressurized.

Many of these tanks are of a spherical configuration, or at least include a convex or rounded top. When ladders are required to reach the top it is necessary for the ladder to be positioned such that it clears the outer perimeter of the tank while at the same time being sufficiently close to the port to provide a convenient work station for access to the port closure system. In prior art systems, the larger the tank, the further the ladder is from the top port, often requiring either an additional platform on top of the tank or requiring the user to lean or climb over the tank beyond the top of the ladder, creating an inconvenience to the operator and minimizing the support function of the ladder.

It is desirable that the tank and ladder footprint be kept to a minimum, particularly if the tank assembly is portable and designed to be moved about. For this reason almost all ladders are vertical or near vertical for their entire length.

It is known, for example, to place curved ladders on railway tank cars. However, such curved ladders are not designed to make a work station where an operator can release a pressure closure interlock and perform work on the area of the closure port or access port while confined to the work station provided by the ladder. Further, the railway tank car ladders are not meant for frequent use and do not serve as an operator support system and a work station for routine, oft repeated operations.

Another recent example of a tank ladder is shown and described in U.S. Pat. No. 4,848,517, entitled “TANK SAFETY LADDER”. As there shown, the ladder is vertical and outboard from the peripheral outer wall of the tank with a horizontal platform mounted at the top of the ladder and extending over the top portion of the tank. The '517 patent also discusses various prior art ladders having various sections at different angles to accommodate the convex exterior of the tank. As there shown, the ladder is vertical and outboard from the peripheral outer wall of the tank, with a horizontal platform mounted at the top of the ladder and extending over the top portion of the tank. The '517 patent also discusses various prior art ladders for gaining access to the top of various tanks, including a segmented ladder having various sections at different angles to accommodate the convex exterior of the tank.

None of the prior art structures disclose a curvilinear ladder which forms the integral part of a work station for an operator to comfortably occupy while working on an access port or closure system of a pressure vessel having a convex rounded top.

The importance of this feature is made clear when the function of the pressure tank of a bulk abrasive blaster system is taken into account. The system provides a controlled mixture of dry abrasive or non-abrasive media and compressed air to a blast nozzle. The abrasive blast stream may be used to prepare the surface being blasted for the application of a protective coating or may be used for simple removal of unwanted surface defects, or other typical blasting operations. The bulk abrasive blaster is one of the components of the abrasive blasting system. The system typically comprises an air compressor, a moisture removal device, the bulk abrasive blaster, a blast line and a blast nozzle.

In the most typical applications, the bulk abrasive blaster comprises a pressure tank or pressure vessel having a rounded or convex top with a top closure assembly adapted to be placed in communication with the outlet of an abrasive storage hopper for filling the tank when the abrasive or media therein is depleted. A pressure system is utilized for pressuring the tank when it contains an operable amount of abrasive. Once the tank is pressurized, the abrasive media or other media flows through an outlet and into a blast line where it is propelled through the blast nozzle.

When the system is shut down, or in blowdown condition, the pressure valve is closed and a blowdown valve is opened to relieve the pressure in the vessel and permit it to achieve ambient pressure levels.

### SUMMARY OF THE INVENTION

The subject invention is a ladder devised work station for providing access to a tank having a spherical or convex curved top portion and is equally suitable for any tank having a convex shape. The ladder provides easy and safe access to the top center of the tank while minimizing the footprint of the tank and ladder assembly, enhancing portability and mobility of the tank assembly. In addition, the tank includes an integral hand grip at the top of the ladder for supporting the user when at the top of the ladder. A safety harness may also be secured to the hand grip to further maximize the safety of the operation.

The subject invention provides a ladder which has side support rails of a continuous curvilinear design for following the contour to the tank exterior. In the preferred embodiment the lower portion of the ladder is vertical with the upper portion curved to fit the contour of the convex top of the tank. However, it may be desirable, particularly for larger tanks, to have the lower portion at an angle for ease of use and increased safety.

In the preferred embodiment the ladder comprises two parallel side rails which are curved at the top end to generally conform to the convex top of a tank. Rungs are mounted at desired spaces and extend between the two side rails. The assembly is secured to the tank at the desired location. A hand grip spaced outwardly from the top of the ladder and directly on the tank provides additional convenience during operation. A harness may be directly attached to the tank or the ladder.

The ladder of the subject invention permits the operator to stand securely positioned on the middle section rung of the ladder as he reaches the top and obtains access to a port or opening positioned in the top center of the tank. The ladder also provides comfortable support for the user when he leans over the top of the tank by providing support for his thighs and a portion of his torso.

In the preferred embodiment of the invention, the ladder provides a work station as an integral part of the ladder for use in combination with the camlock closure system shown in my aforementioned U.S. Pat. No. 7,850,214. The camlock assembly is a first level safety feature that alerts the operator of the presence of air pressure within the tank by allowing air to leak from the closure assembly provided that the closure is opened in the proper sequence. The proper sequence requires that all camlock handles be swung into the open position prior to moving any of the swing bolts, thereby reducing the tension on the swing bolts. This allows the closure head to slightly rise and leak air pressure, thereby alerting the operator to the presence of air pressure. This system varies from the prior art by providing a secondary safety interlock that will require proper sequence of opening. However, the curved ladder work station can be used with any closure system without departing from the scope and spirit of the invention.

It is important in the operation of the system that the tank closure assembly not be opened at any time when the pressure tank is at a pressure higher than the ambient external pressure. This is particularly important when the system is operated in such a manner that the bulk abrasive blaster system, including the pressure tank, is maintained in a pressurized state when in an off condition. However, caution must be taken at all times to make certain the vessel is at ambient external pressure before the closure assembly is opened for any reason.

In normal depressurizing operation, the air inlet valve on the tank is closed. The blowdown valve on the tank is then opened to relieve the pressure in the tank. Once airflow from the blowdown valve stops and the tank is depressurized, the closure assembly may be opened. This operation takes place by an operator who is positioned on the integral work station of the curved ladder of the subject invention. Typically a pressure indication valve 95 is provided near the closure assembly to provide a check point for confirming that the vessel is at ambient pressure before opening the closure assembly.

The closure assembly serves as an access port that can be opened with or without the use of tools. The safe operation of the closure system requires that the pressure vessel first be completely free of internal air pressure prior to opening the closure. A hazardous situation occurs when the operator fails to vent the air pressure prior to attempting to open the closure. The compressed air inside the tank can contain a dangerously high level of energy which can propel objects. This air pressure will also cause the failure of the closure assembly if some of the swing bolts, as described in the aforementioned U.S. Pat. No. 7,850,214, are moved into the open position with the presence of air pressure within the pressure tank or pressure vessel. At all times the operator is dependent upon the functionality provided by the curved ladder work station to perform the opening and maintenance operation at the closure port.

The curved ladder work station permits the operator to work by staying on the ladder and resting his torso on the top several rungs. This frees up both hands to operate the closure or other work at the top of the vessel. The handgrip component or bar 50 permits the operator to secure himself when pulling on the closure handles 80. As is inherent with most cam mechanisms, there is a non-linear force throughout the travel of the cam handles, beginning with a significant force which quickly diminishes during travel. The bar gives additional support and security in dealing with the handles as the work force is reduced.

The combination of the curved ladder and the bar guides the operator away from requiring additional support, such as by hooking one leg around the ladder side rails or through one of the rungs. The ladder curved side rails are designed to be sufficiently close to the tank wall to discourage the operator from placing a leg through the rungs and between the ladder and tank for support.

### BRIEF DESCRIPTION OF THE DRAWINGS

FIG. 1 is a side view of the ladder of the subject invention, shown as attached to a circular or cylindrical tank having a convex curved top and showing the use of the hand grip and a tethered harness.

FIG. 2 is a side view of the ladder of the subject invention, shown as attached to a circular or cylindrical tank having a convex curved top and convex curved bottom.

FIG. 3 is similar to FIG. 2, showing a user accessing a port in the center of the top of the tank using the ladder of the subject invention.

FIG. 4 is a side view of the ladder.

FIG. 5 is a perspective view of the ladder.

### DESCRIPTION OF THE PREFERRED EMBODIMENT

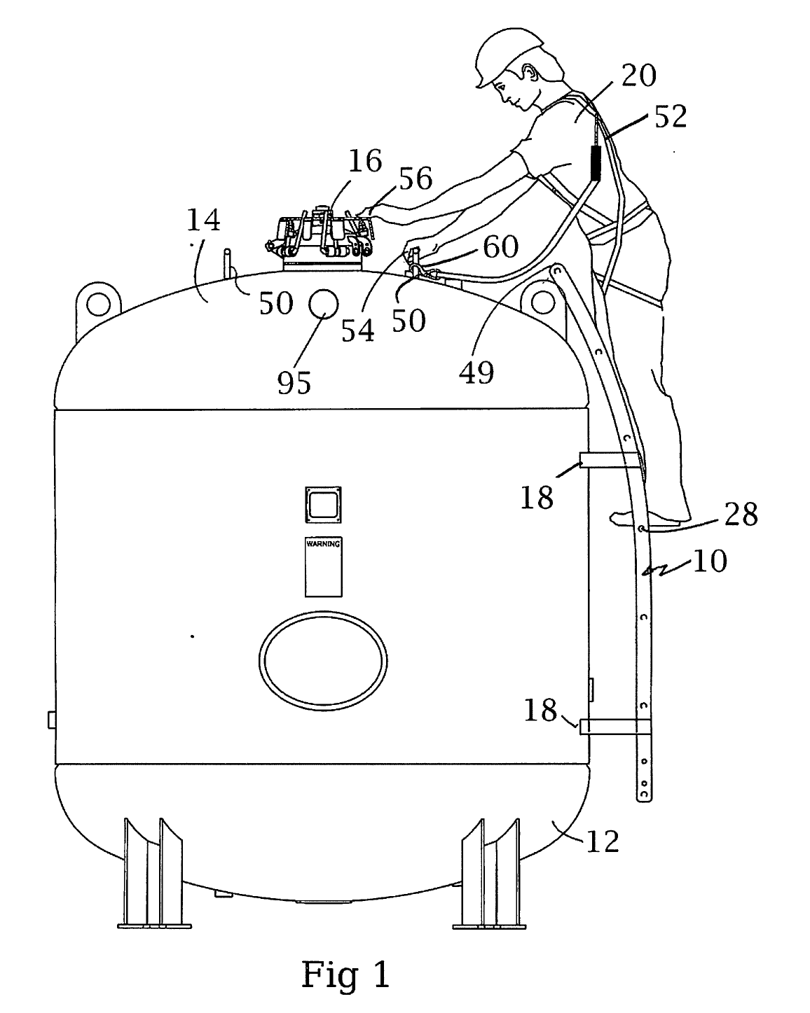

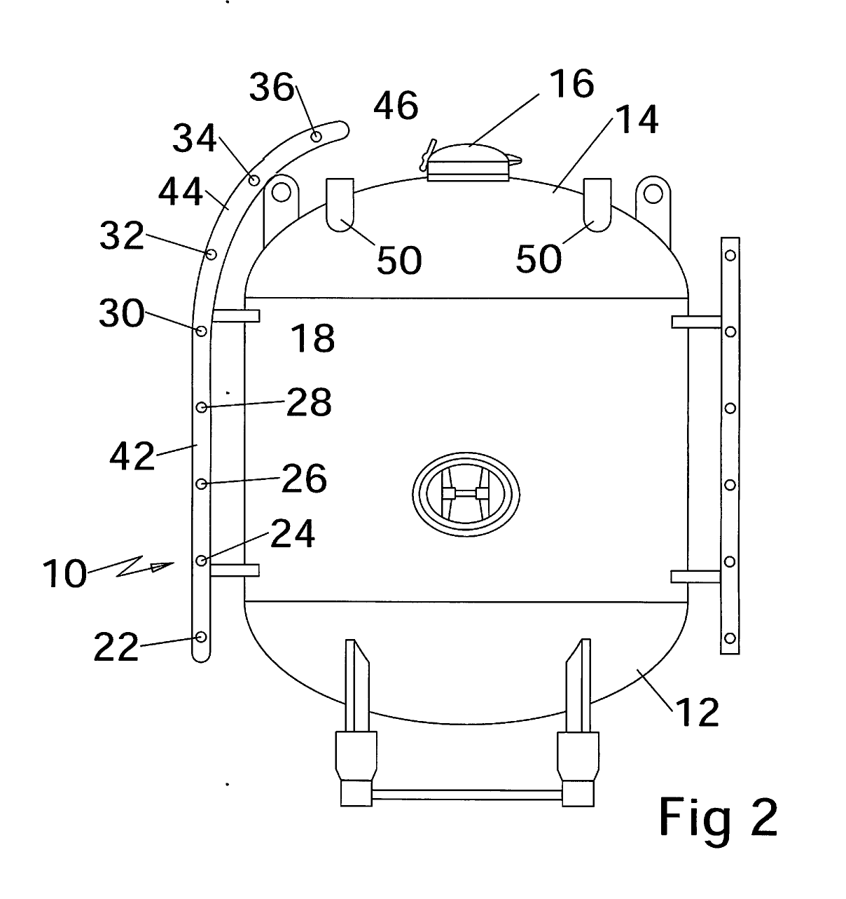

The ladder with side rails 10 of subject invention is shown in FIGS. 1 and 2 as mounted on a typical tank 12 having a convex, curved top 14 with a central top port or opening 16. The ladder may be secured to the side wall of the tank 12 by a series of mounting brackets 18 which may be bolted, welded or otherwise secured to the tank 12 and the ladder rails 10 in the well known manner. The ladder terminates at point 49, outboard of the hand grip 50, also visible in FIGS. 1 and 2. This permits the operator to engage the hand grip with one hand 54 while freeing the other hand 56 for work, further supporting and stabilizing the operator 20 as he completes his work. Where desired, a tethered harness 52 may be utilized with a fastener 60 secured to either the hand grip 50 or the top rung of the ladder to further enhance operation.

A sentinel ball valve 95 near the closure system 16 is opened prior to any action on the closure system. This confirms that the pressure is at the desired level before initiation of operation on the closure system 16.

Also, as shown in the recently issued U.S. Pat. No. 8,708,779 owned by the present assignee, the blowdown muffler reduces the blowdown noise volume, permitting opening of the ball valve during tolerable noise conditions.

The use of the curved ladder working station, the safety interlock closure system with extended handles, the ball valve relief valve and the blowdown muffler provides a convenient and useful combination for managing the operation of the closure system on the central, top port of the pressure vessel.

As shown in FIGS. 1, 2 and 4, when a operator 20 is positioned on the ladder for gaining access to the port 16, he may lean over the top 14 of the tank while still engaging the ladder for additional comfort and support. Specifically, when his feet are resting on rung 28 of the ladder, he can rest his thighs against rung 32 and lean over at rung 34 while supporting his weight on rungs 34 and 36. This not only increases the safety of the user, but also increases his comfort while at the same time freeing both of his hands for work without compromising support.

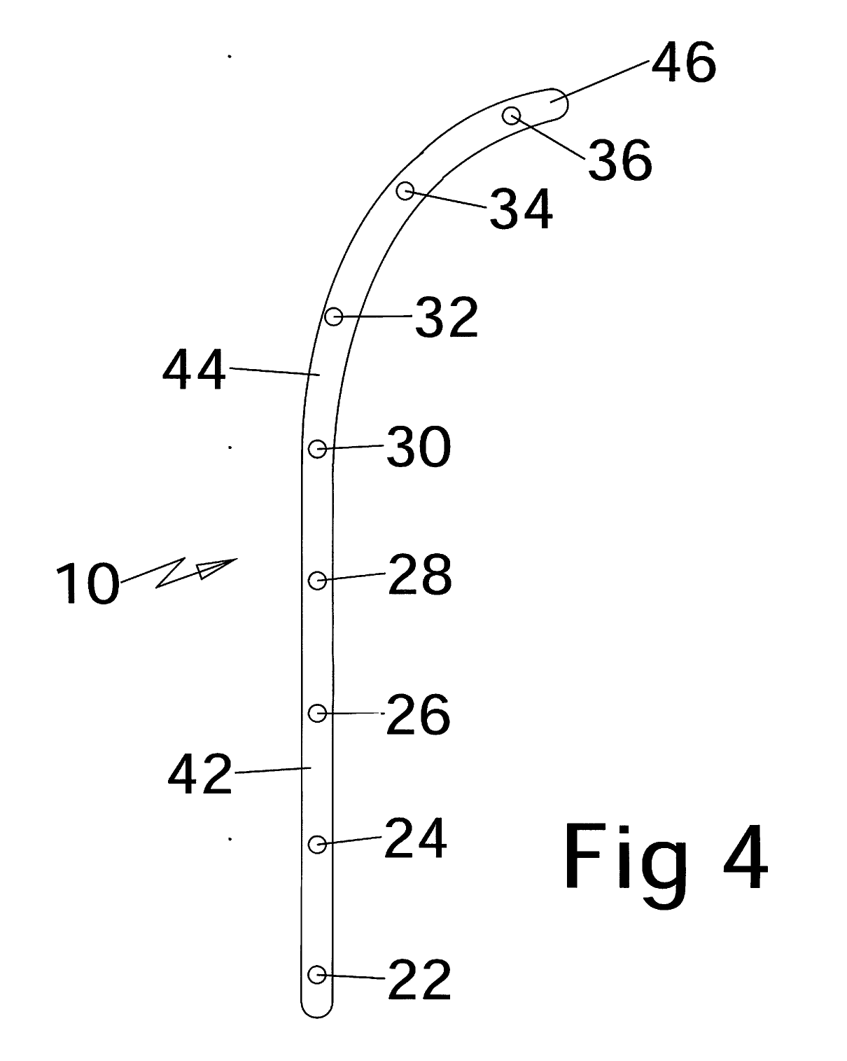

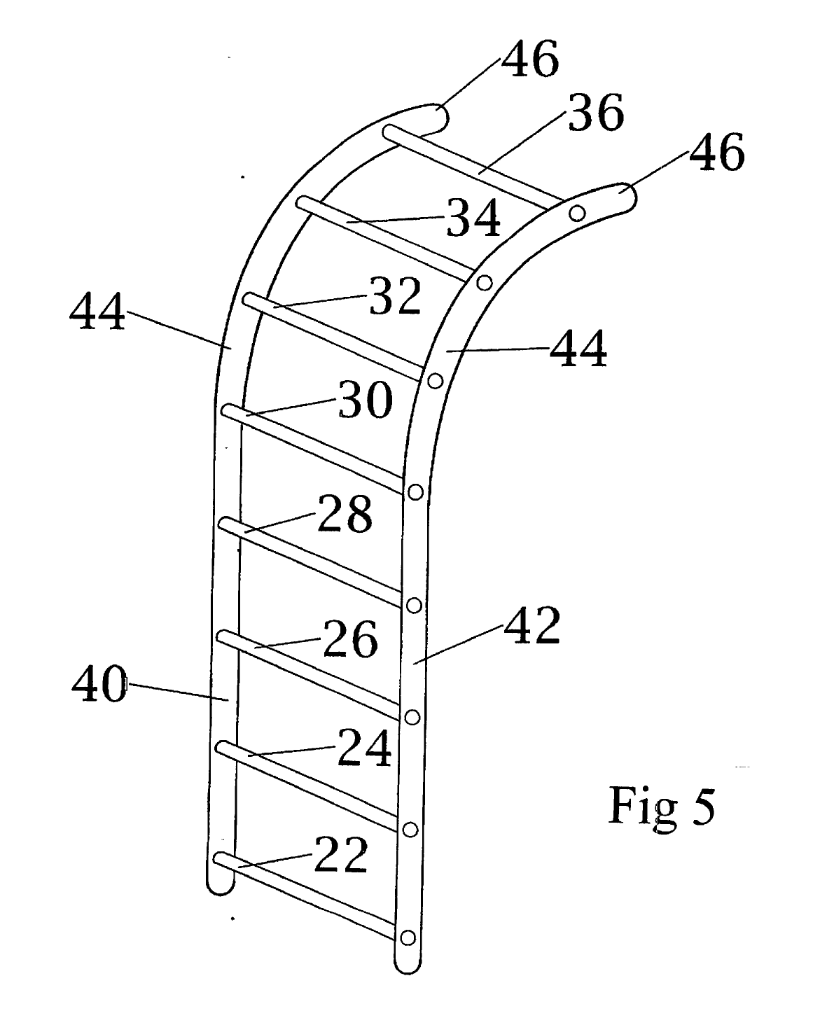

The ladder configuration is shown in FIGS. 4 and 5. As there shown, the ladder comprises a pair of parallel side rails 40 and 42. The rails are curved at the upper end 44 and terminate at a point inboard of the vertical section of the rail, as shown at 46 such that the ladder may extend over the top of the tank as shown in FIGS. 1 and 2. A plurality of ladder rungs 22, 24, 26, 28, 30, 32, 34 and 36 extend between and are secured to the side rails 40, 42 in typical manner. The rungs are spaced from one another to accommodate easy ascension and descension by the average person. Typically, the handgrip 50 is mounted directly on the tank, but could be placed at the end of the ladder, if desired.

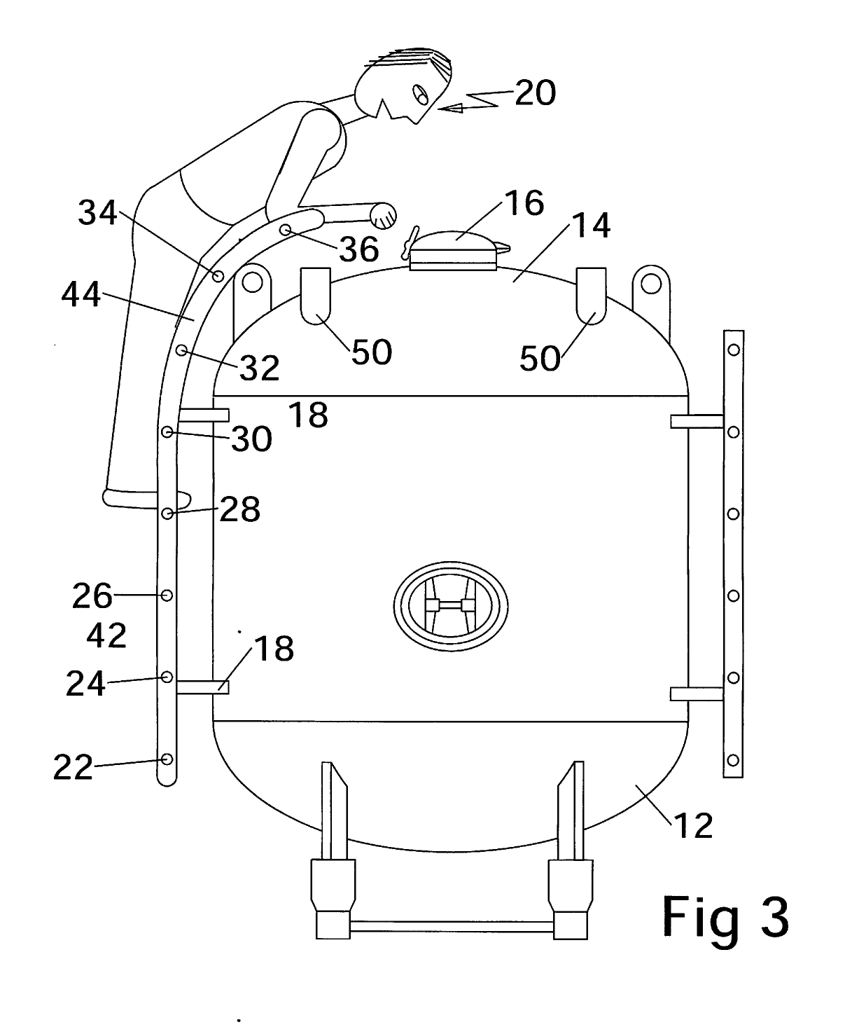

As shown in FIGS. 1-3, the ladder may be mounted on a tank 12 by a plurality of mounting brackets 18, in the well known manner.

In use the ladder of the subject invention enhances both the comfort and safety of the operator while permitting him to use his body for support and freeing both arms and hands for work.

The curved ladder work station permits the operator to work by staying on the ladder and resting his torso on the top several rungs. This frees up both hands to operate the closure or other work at the top of the vessel. The handgrip component or bar 50 permits the operator to secure himself when pulling on the closure handles 80. As is inherent with most cam mechanisms, there is a non-linear force throughout the travel of the cam handles, beginning with a significant force which quickly diminishes during travel. The bar 50 gives additional support and security in dealing with the handles as the work force is reduced.

As particularly shown in FIGS. 1 and 2, the side rails 10 are positioned sufficiently close to the sidewall of the pressure vessel to prevent placing an operator's leg through a rung on the ladder for additional support.

The combination of the curved ladder 10 and the bar 50 guides the operator away from requiring additional support, such as by hooking one leg around the ladder side rails or through one of the rungs.

The railway tank car ladders are not meant for frequent use and do not serve as operating platforms for routine, oft repeated operations. The opening and closing of a blast pot pressure vessel occurs regularly, as often as three times a day during operation on jobs which may last a number of days or even months of blasting. The curved ladder working station of the present invention is specifically designed as a work support system rather than solely as access structure for inspection or other operations where work is not actually performed under relatively hazardous conditions. By keeping the operator at the lowest possible working height above the ladder and by freeing up both hands for performing the work operations provides the most useful work station. This is not an objective of prior are curved ladders.

While certain embodiments and features of the invention have been described in detail herein, it should be understood that the invention incorporates all modifications and enhancements within the scope and spirit of the following claims. It also permits the operator to stay in a lower position on the ladder, keeping more of his torso in a fully supported position.

What is claimed is:

1. A ladder and support assembly for providing a work station for opening, closing and maintaining a closure system of bulk abrasive pressure vessel comprising:
a. A pair of parallel side rails and a plurality of rungs attached to the side rails, each side rail having a straight section at one end and a curved section at the other end, wherein the curved section is sufficiently close to the pressure vessel to prevent an operator leg from being placed through a rung and between the ladder and the pressure vessel;
b. The plurality of rungs extending between and secured to the side rails, with at least one rung
c. Positioned in the straight section of the side rails and at least one rung positioned in the curved section of the side rails; and
d. A hand grip separate from the ladder for supporting the hand of the user independently of the ladder.

2. The ladder and support assembly of claim 1, further including at least one mounting bracket for securing the ladder to a wall.

3. A ladder and support assembly for defining a work station for a tank having a vertically extending side wall and a top of a convex curved profile, with an access point near the top center of the convex curved top, the ladder and support assembly comprising:
a. A pair of parallel side rails, each side rail having a straight section at one end and a curved section at the other end;
b. A plurality of rungs extending between and secured to the side rails, with at least one rung positioned in the straight section of the side rails and at least one rung positioned in the curved section of the side rails;
c. At least one mounting bracket for securing the ladder to tank side wall; and
d. A hand grip-mounted on the convex curved top of the tank between the ladder and the access point.

4. The ladder and support assembly of claim 3, wherein the straight sections of the parallel side rails are substantially vertical.

5. The ladder and support assembly of claim 3, further including a harness to be worn by the user, the harness having a tether which may be secured to the hand grip.

6. The ladder and support assembly of claim 3, wherein the curved sections of the parallel side rails extend along the convex curved top of the tank.

7. The ladder and support assembly of claim 6, wherein the curved end of the side rails terminates at a point near the access point in the convex curved top of the tank.

8. A ladder and support assembly for a tank having a vertically extending side wall and a top of a convex curved profile, with an access point near the top center of the convex curved top, the ladder and support assembly for defining a work station permitting hands-free work on at the access point, the ladder and support assembly comprising:
a. A pair of parallel side rails, each side rail having a straight section at one end and a curved section at the other end, with the curved section of each side rail terminating at a point near the access point near the top center of the convex curved top;
b. A plurality of rungs extending between and secured to the side rails, with at least one rung positioned in the straight section of the side rails and at least one rung positioned in the curved section of the side rails, the curved portion of the side rails being sufficiently close to the tank side wall to prevent placement of the leg of an operator through a rung and between the ladder and the tank sidewall; and
c. At least one mounting bracket for securing the ladder to tank side wall.

9. The curved ladder and support assembly of claim 8, further comprising a hand grip mounted on the tank between the access point and the ladder.
